(19) United States
(12) Patent Application Publication
(10) Pub. No.: US 2026/0054176 A1
(43) Pub. Date: Feb. 26, 2026

(54) OPERATION CONTROL METHOD AND APPARATUS FOR VIRTUAL ARTICLE, AND ELECTRONIC DEVICE

(71) Applicant: NETEASE (HANGZHOU) NETWORK CO., LTD., Hangzhou, Zhejiang (CN)

(72) Inventors: Yupeng SU, Hangzhou, Zhejiang (CN); Zhi DENG, Hangzhou, Zhejiang (CN); Yimin TU, Guangzhou, Guangdong (CN)

(73) Assignee: NETEASE (HANGZHOU) NETWORK CO., LTD., Hangzhou, Zhejiang (CN)

(21) Appl. No.: 19/104,714

(22) PCT Filed: Jun. 30, 2023
(86) PCT No.: PCT/CN2023/105035

§ 371 Date: Feb. 19, 2025

(30) Foreign Application Priority Data
Aug. 22, 2022 (CN) 202211008075.5

(51) Int. Cl. A63F 13/56

(52) U.S. Cl. CPC A63F 13/56

(57) ABSTRACT

An operation control method for a virtual article includes: in response to a movement control operation for a first virtual article in a first storage container, controlling the first virtual article to move; determining, from among a plurality of sub-containers, a target sub-container for the placement of the first virtual article; in response to the first virtual article moving to a second display area, and on the basis of a first current position of the first virtual article in the second display area, determining a first specified sub-area in the second display area, and performing control to display the target sub-container in the first specified sub-area; and in response to the ending of the movement control operation, placing the first virtual article in the target sub-container.

### CROSS-REFERENCE TO RELATED APPLICATIONS

The present disclosure is a U.S. National Phase application of International Application No. PCT/CN2023/105035, filed on Jun. 30, 2023, which is based on and claims the priority to the Chinese Patent Application No. 202211008075.5, entitled “Operation control method and apparatus for virtual article, and electronic device”, filed on Aug. 22, 2022, the entire contents of both of which are incorporated herein by reference for all purposes.

### TECHNICAL FIELD

The present disclosure relates to the field of game technology, and in particular to an operation control method and apparatus of a virtual object, and an electronic device.

### BACKGROUND

In some game scenes, players are usually required to collect and cultivate various game materials. According to game requirements, players need to transfer materials between the warehouse area and the preparation area at a high frequency. However, since the preparation area is usually divided into different types of storage slots, and some different types of storage slots can store the same material. For example, the preparation area has an insurance slot, a weapon slot, an equipment slot, a consumable slot, etc., consumable props can be stored in the insurance slot or the consumable slot.

### SUMMARY

According to one aspect of the present disclosure, an operation control method of a virtual object is provided, including: providing a graphical user interface through a terminal device, wherein the graphical user interface includes a first display area of a first storage container and a second display area of a second storage container; wherein the second storage container includes a plurality of sub-containers; controlling a first virtual object to move, in response to a movement control operation for the first virtual object in the first storage container; determining a target sub-container for placing the first virtual object from the plurality of sub-containers; determining a first designated sub-area in the second display area based on a first current position of the first virtual object in the second display area, in response to the first virtual object moving to the second display area, and controlling the target sub-container to be displayed in the first designated sub-area of the second display area; wherein the first current position is located in the first designated sub-area, or a distance between the first current position and the first designated sub-area is smaller than a preset threshold; and placing the first virtual object in the target sub-container, in response to end of the movement control operation.

According to one aspect of the present disclosure, an electronic device is also provided, including a processor and a memory, wherein the memory stores computer executable instructions executable by the processor, and the processor executes the computer executable instructions to implement the operation control method of the virtual object of the first aspect.

According to one aspect of the present disclosure, a non-transitory computer-readable storage medium is also provided, having computer executable instructions stored thereon, wherein the computer executable instructions prompt a processor to implement the operation control method of the virtual object of the first aspect when called and executed by the processor.

### BRIEF DESCRIPTION OF THE DRAWINGS

FIG. 1 is a flow chart of an operation control method of a virtual object provided by at least one embodiment of the present disclosure;

FIG. 2 is an interactive schematic diagram of operation control of a virtual object provided by at least one embodiment of the present disclosure:

FIG. 3 is another interactive schematic diagram of operation control of a virtual object provided by at least one embodiment of the present disclosure:

FIG. 4 is another interactive schematic diagram of operation control of a virtual object provided by at least one embodiment of the present disclosure:

FIG. 5 is another interactive schematic diagram of operation control of a virtual object provided by at least one embodiment of the present disclosure:

FIG. 6 is another interactive schematic diagram of operation control of a virtual object provided by at least one embodiment of the present disclosure:

FIG. 7 is a structural schematic diagram of an operation control apparatus of a virtual object provided by at least one embodiment of the present disclosure; and

FIG. 8 is a structural schematic diagram of an electronic device provided by at least one embodiment of the present disclosure.

### DETAILED DESCRIPTION

In order to make the purposes, technical solutions and advantages of the embodiments of the present disclosure clearer, the technical solutions of the present disclosure will be clearly and completely described below in conjunction with the accompanying drawings. The described embodiments are part of the embodiments of the present disclosure, but not all of the embodiments. Based on the embodiments in the present disclosure, all other embodiments obtained by those skilled in the art without creative work are within the protection scope of the present disclosure.

In some game scenes, players are usually required to collect and cultivate various game materials. For example, in survival escape games, according to game requirements, players need to transfer materials between the warehouse area and the preparation area at a high frequency. However, since the preparation area is usually divided into different types of storage slots, and some different types of storage slots can store the same material. For example, the preparation area has an insurance slot, a weapon slot, an equipment slot, a consumable slot, etc., consumable props can be stored in the insurance slot or the consumable slot.

In the related art, when a player moves an object from a warehouse area to a preparation area, and there are a plurality of storage slots in the preparation area that can place the object, if the storage slot that can place the object is not fully displayed in the interface, the player needs to drag the object and slide it up and down in the preparation area to find the corresponding storage slot, and then let go after finding the corresponding storage slot to complete the object transfer. However, this operation manner requires the players to have certain understanding on the object type and each storage slot, so that they can quickly find the storage slot where the object can be placed during the dragging process. It is difficult for novice players to quickly locate the storage slot where the object can be placed. They need to manually slide up and down to find the storage slot where the preparation area can be placed each time. When there are many devices and a large number of objects that need to be transferred, the operation will take a lot of time, the operation efficiency is low, and the players need to have certain understanding on the game. The trial and error cost is high, resulting in decrease in operation efficiency and game experience of the players.

Based on this, the embodiment of the present disclosure provides an operation control method and apparatus of a virtual object, and an electronic device, and the technology can be applied to electronic devices such as mobile phones, computers, notebooks, or tablet computers.

The operation control method of a virtual object in one embodiment of the present disclosure can be run on a local terminal device or a server. When the operation control method for the virtual object runs on the server, the method can be implemented and executed based on the cloud interaction system, wherein the cloud interaction system includes a server and a client device.

In at least one embodiment, various cloud applications can be run under the cloud interaction system, such as cloud games. Taking the cloud game as an example, the cloud game refers to a game mode based on cloud computing. In the operation mode of cloud games, the operation subject of the game program and the game screen presentation subject are separated, the storage and operation of the operation control method for the virtual object are completed on the cloud game server, and the client device is used for receiving and sending data and presenting the game screen. For example, the client device can be a display device with data transmission functions close to the user side, such as a mobile terminal, a TV, a computer, a handheld computer, etc.; but the cloud game server in the cloud performs information processing. When playing the game, the player operates the client device to send an operation instruction to the cloud game server. The cloud game server runs the game according to the operation instruction, encodes and compresses the game screen and other data, and returns it to the client device through the network. Finally, the game screen is decoded and output by the client device.

In at least one embodiment, taking the game as an example, the local terminal device stores the game program and presents the game screen. The local terminal device is used to interact with the player through a graphical user interface, that is, the game program is downloaded, installed and run through an electronic device conventionally. The local terminal device may provide the graphical user interface to the player in a variety of ways, for example, the graphical user interface may be rendered and displayed on the display screen of the terminal, or provided to the player through holographic projection. For example, the local terminal device may include a display screen and a processor, the display screen is used to present a graphical user interface, the graphical user interface includes a game screen, and the processor is used to run the game, generate a graphical user interface, and control the display of the graphical user interface on the display screen.

In a possible implementation, the embodiment of the present disclosure provides an operation control method of a virtual object, providing a graphical user interface through a terminal device, wherein the terminal device may be the local terminal device mentioned above, or may be a client device in the cloud interaction system mentioned above. Generally, the terminal device provides a graphical user interface, the graphical user interface includes a first display area of a first storage container and a second display area of a second storage container; the second storage container includes a plurality of sub-containers. The sub-containers included in the second storage container are used to place virtual objects, each sub-container can place a plurality of virtual objects, and each sub-container includes a plurality of placement positions, and each placement position can place a virtual object. In other words, the second storage container has a plurality of storage partitions (i.e., the above-mentioned sub-containers), each partition is used to place a plurality of virtual objects, and each partition is used to place different types of virtual objects.

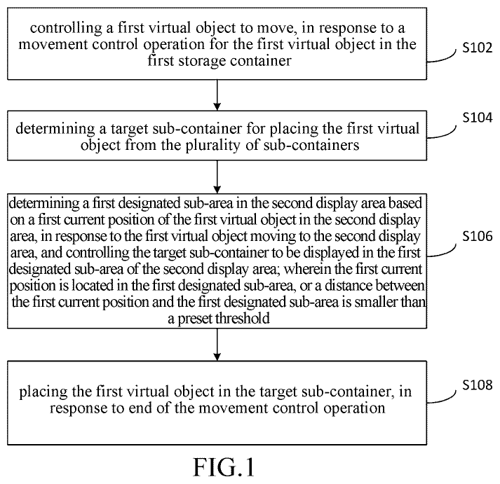

As shown in FIG. 1, the operation control method of the virtual object includes the following steps:
step S102, controlling a first virtual object to move, in response to a movement control operation for the first virtual object in the first storage container;
step S104, determining a target sub-container for placing the first virtual object from the plurality of sub-containers.

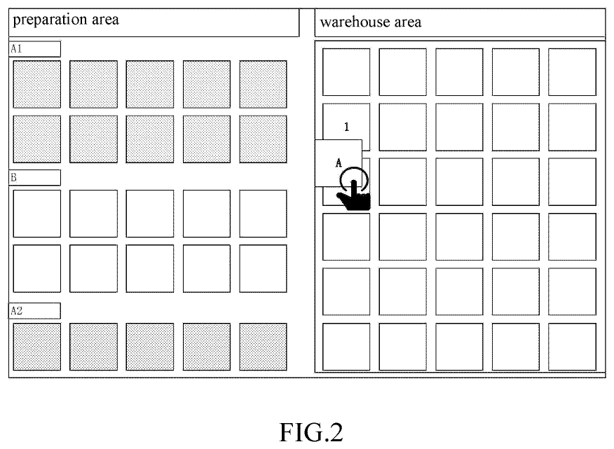

The above-mentioned first storage container usually refers to the virtual warehouse area set in the game, and the above-mentioned second storage container usually refers to the virtual preparation area set in the game, wherein the virtual preparation area includes a plurality of different types of storage slots (i.e., the above-mentioned sub-containers). Usually, different sub-containers are used to place different types of virtual objects, and some different types of sub-containers can store the same type of virtual object. The above-mentioned first virtual object can be a virtual weapon, virtual medicine, virtual equipment, virtual clothing, etc. set in the game. The second display area of the second storage container can display the plurality of sub-containers at the same time, as shown in FIG. 2, wherein the second display area displays three sub-containers (such as the three sub-containers A1, B and A2 in the figure), each of which has a plurality of storage areas for placing virtual objects. As shown in FIG. 2, the A1 sub-container includes 10 rectangular blocks, which are storage areas for placing virtual objects.

The above-mentioned movement control operation for the first virtual object can be a touch sliding operation acting on the first virtual object. Usually, the first virtual object placed at the target position of the first storage container can be clicked first, and the mouse or finger can be moved in the clicked state, to control the position of the first virtual object to change with the movement of the finger or mouse, and then the first virtual object can be dragged out from the target position, to control the movement of the first virtual object in the first display area. At this time, the system will intelligently identify the first virtual object, and then determine the target sub-container in which the first virtual object can be placed among the plurality of sub-containers of the second storage container. The target sub-container can be one or more.

For example, based on the size, type, attribute and other information of the first virtual object, as well as the storage space, type and other information of the sub-container, the sub-container that can match the first virtual object can be first identified. For example, if the first virtual object is a pistol, a weapon box for placing the pistol can be found in the plurality of sub-containers. For another example, if the first virtual object is a hat, a clothing box for placing clothes can be found in plurality of sub-containers. In addition, a safe can usually also place a pistol and a hat, so the sub-containers that can match the first virtual object can be a weapon box and a safe, or a clothing box and a safe. Then, based on the storage space of the matching sub-container and the size of the first virtual object, it can be determined whether there is space to place the first virtual object. If so, it can be determined that the matching sub-container is the target sub-container.

Step S106, a first designated sub-area is determined in the second display area based on a first current position of the first virtual object in the second display area, in response to the first virtual object moving to the second display area, and the target sub-container is controlled to be displayed in the first designated sub-area of the second display area; wherein the first current position is located in the first designated sub-area, or a distance between the first current position and the first designated sub-area is smaller than a preset threshold.

As can be seen from the above, the second display area of the second storage container is displayed in the graphical user interface. The second display area includes a plurality of sub-containers of different types, such as safes, weapon boxes, equipment boxes, consumable boxes, etc. Consumable props can be stored in safes or consumable boxes. The first current position is the position of the first virtual object in the second display area. The first virtual object can either have its entire object area located within the second display area, or have part of its object area located within the second display area (for example, more than 50% area of the first virtual object is located within the second display area). The first designated sub-area is used to display the target sub-container, that is, the size of the first designated sub-area is the same as the size of the target sub-container. The above preset threshold can be set according to the actual needs of the game, it can be the area where the first designated sub-area is located above the first current position, or the area that located below the first current position. However, the first designated sub-area is usually located in the vicinity of the first current position, and the first virtual object can be moved from the first current position to the first designated sub-area by moving a small distance.

In actual implementations, when the first virtual object is controlled to be removed from the first display area and moved into the second display area, the designated sub-area corresponding to the current position, i.e., the first designated sub-area, is first determined according to the current position of the first virtual object in the second display area, i.e., the first current position. Then the target sub-container is controlled to be displayed in the designated sub-area. The specific control manner may be to control the scrolling of the plurality of sub-containers in the second storage container, so that the displayed target sub-container is displayed in the designated sub-area. Usually, the plurality of sub-containers are arranged and displayed in a certain sequence, such as shown in FIG. 2, arranged in the sequence of sub-container A1, sub-container B, sub-container A2, etc.

Step S108, in response to the end of the movement control operation, the first virtual object is placed in the target sub-container.

During the movement process, the first virtual object is in a state of being clicked or selected and dragged at the same time. The end of the movement control may be the finger of the player leaving the selected and dragged first virtual object, or the mouse popping up, i.e., the drag release operation and the click release. When the terminal device detects the movement control end operation for the first virtual object, the movement of the first virtual object is stopped. In addition, if the movement control of the first virtual object in the first designated sub-area ends, the movement of the first virtual object is stopped first, and then the first virtual object is placed in the corresponding position of the target sub-container, and at the same time, the icon of the first virtual object is displayed at the object placement position of the target sub-container in the second display area.

Specifically, when the target sub-container is displayed in the first designated sub-area of the second display area, if the currently displayed target sub-container is the container where the player wants to place the first virtual object, and the first current position is located in the first designated sub-area, the player can directly let go, or control the mouse to pop up, and place the first virtual object in the target sub-container. If the currently displayed target sub-container is the container where the player wants to place the first virtual object, and the distance between the first current position and the first designated sub-area is less than the preset threshold, that is, the first designated sub-container is located in the vicinity of the first current position, it is necessary to control the first virtual object to move to the first designated sub-area, and then let go, or control the mouse to pop up, and place the first virtual object in the target sub-container. If the currently displayed target sub-container is not the container where the player wants to place the first virtual object, the first virtual object can also be controlled to move in the second display area to find a suitable target sub-container for placing the first virtual object.

In the operation control method of a virtual object, a first virtual object is controlled to move, in response to a movement control operation for the first virtual object in the first storage container; a target sub-container for placing the first virtual object is determined from the plurality of sub-containers; a first designated sub-area is determined in the second display area based on a first current position of the first virtual object in the second display area, in response to the first virtual object moving to the second display area, and the target sub-container is controlled to be displayed in the first designated sub-area of the second display area; wherein the first current position is located in the first designated sub-area, or a distance between the first current position and the first designated sub-area is smaller than a preset threshold; and the first virtual object is placed in the target sub-container, in response to end of the movement control operation. In this implementation, when the first virtual object is moved from the first storage container to the second storage container, the target sub-container where the first virtual object is placed is intelligently identified, and the target sub-container is quickly positioned at the first current position where the first virtual object is located, without requiring the player to drag the object and slide it up and down in the second storage container, thereby reducing the operation time of dragging the object up and down to find the target sub-container, improving the operation efficiency, reducing understanding requirements of the player on the game and the trial and error cost.

The first virtual object is placed in the first position of the first storage container in advance, as shown in square 1 in FIG. 2; the following describes a possible implementation of step S102 of controlling the movement of the first virtual object in response to the movement control operation of the first virtual object in the first storage container:
controlling the first virtual object to move out from the first position, in response to the movement control operation for the first virtual object in the first storage container.

For example, in the initial state, the first virtual object is placed in the first position of the first storage container, and the first position can be displayed in a square form, as shown in FIG. 2, the first virtual object A is placed in the first position of the first storage container in advance, that is, square 1 in the figure. When the first virtual object is clicked or selected by the finger or mouse, the first virtual object is controlled to move in the first display area of the first storage container by the dragging operation of the first virtual object, as shown in FIG. 2, the warehouse area in the figure is the first display area of the first storage container, and the first virtual object is controlled to move out from the first position, that is, the first virtual object is moved out from square 1 of the warehouse area. At this time, the icon of the first virtual object displayed in square 1 disappears.

In this implementation, when the first virtual object is controlled to move out from the first position, immediate feedback is given to the movement control operation of the player, which is conducive to understanding and operation of the player.

The following describes a possible implementation of the step S102 of determining the target sub-container for placing the first virtual object from the plurality of sub-containers:
determining the target sub-container capable of placing the first virtual object from the plurality of sub-containers, according to an object type of the first virtual object and a container type of the sub-container.

The above-mentioned first display area is usually located in the right area of the graphical user interface, and the above-mentioned second display area is usually located in the left area of the graphical user interface. FIG. 2 is an interactive schematic diagram of the operation control of a virtual object, which includes a warehouse area (corresponding to the above-mentioned first display area) and a preparation area (corresponding to the above-mentioned second display area). Specifically, when it is monitored that the first virtual object is moved out from the first position, according to the object type and the container type of the sub-container, the target sub-container for placing the first virtual object is determined from different sub-containers.

Usually, different container types indicate that the sub-container is used to place virtual objects of the corresponding type, such as weapon boxes are used to place weapons (such as pistols, knives, etc.), clothing boxes are used to place clothes, hats, shoes, etc., and safes are used to place consumables, etc. Therefore, according to the object type of the first virtual object and the container type of the sub-container, the target sub-container for placing the first virtual object can be determined from the plurality of sub-containers. The target sub-container can be one or more. If there are a plurality of sub-containers, it means that the first virtual object can be placed in different types of sub-containers.

In this implementation, when the first virtual object moves in the first display area, the target sub-container for placing the first virtual object can be intelligently identified according to the object type and the container type.

The above-mentioned second storage container includes a plurality of sub-containers arranged in a designated sequence; a possible implementation of controlling the target sub-container to be displayed in the first designated sub-area is:
controlling the second display area to be scrolled, such that the target sub-container in the plurality of sub-containers is displayed in the first designated sub-area; wherein the designated arrangement sequence of the plurality of sub-containers is unchanged.

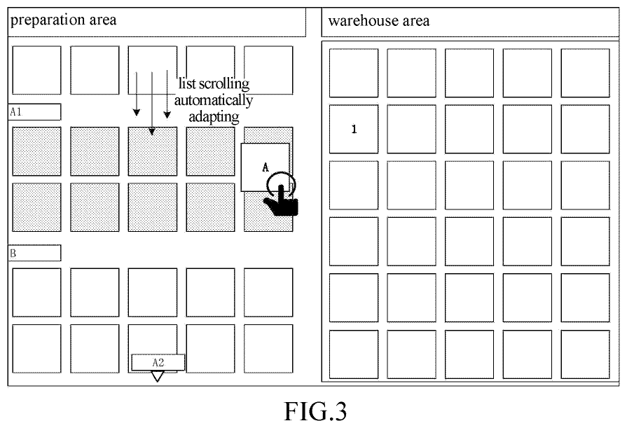

For example, as shown in FIG. 3, the list is controlled to scroll, that is, the second display area is controlled to be scrolled, such that the target sub-container in the plurality of sub-containers of the second storage container is scrolled to the first designated sub-area, and the target sub-container in the plurality of sub-containers is displayed in the first designated sub-area.

Another possible implementation is: controlling the target sub-container in the plurality of sub-containers to move out from a current position and move to the first designated sub-area. Specifically, the second display area is controlled to remain stationary, that is, the second storage container is controlled to remain stationary, and the target sub-container among the plurality of sub-containers is moved out from the current position of the second storage container and moved to the first designated sub-area, so that the target sub-container is displayed in the first designated sub-area. The above-mentioned target sub-containers include one or more, which are generally displayed in sequence in the second display area.

The following is described according to step S106, a possible implementation of controlling the target sub-container to be displayed in the first designated sub-area of the second display area when there are a plurality of target sub-containers is:
controlling the second display area to be scrolled, such that the first sub-container in the target sub-containers closest to the first current position is displayed in the first designated sub-area.

In actual implementation, the first virtual object is clicked or selected, as shown in FIG. 3, after object A (that is, the above-mentioned first virtual object) is dragged from the warehouse area on the right (that is, the above-mentioned first display area) to the preparation area on the left (that is, the above-mentioned second display area), the first designated sub-area is determined according to the position of the first virtual object in the preparation area, that is, the first current position of the second display area. Then, according to the distance between all target sub-containers and the first current position, the manner for determining this distance can involve using the Y-axis of the preparation area as the criterion, the sub-container closest to the first current position is controlled to be displayed in the first designated sub-area of the preparation area, as shown in FIG. 3, the list (i.e., a plurality of sub-containers) in the preparation area of the second display region will scroll downward, the first sub-container A1 in the target sub-container closest to the first current position is displayed in the first designated sub-area corresponding to the first current position where the first virtual object A is located.

In this implementation, when the first virtual object is dragged to the second display area, the list of plurality of sub-containers is controlled to scroll, so that the target sub-container closest to the first virtual object is displayed in the first designated sub-area, so that there is sufficient feedback on which position the virtual object can be stored in, which further improves the operation efficiency.

Further, when there are a plurality of target sub-containers, another possible implementation of controlling the target sub-container to be displayed in the first designated sub-area when there are a plurality of target sub-containers is: controlling the plurality of target sub-containers to move out from the current position, such that the first sub-container in the target sub-containers closest to the first current position is moved to the first designated sub-area, and a second sub-container in the target sub-containers other than the first sub-container is moved to an adjacent area following the first sub-container; wherein the first sub-container and the second sub-container are arranged in the designated sequence.

Specifically, the second display area is controlled not to move, that is, the list of plurality of sub-containers is controlled not to scroll, and the plurality of target sub-containers are directly moved out from the current position, and the first sub-container in the plurality of target sub-containers closest to the first current position is controlled to be moved to the first designated sub-area. Since the plurality of target sub-containers have a designated arrangement sequence, the second sub-containers in the target sub-containers other than the first sub-container also need to be sorted in the designated sequence and moved after the first sub-container, so that the second sub-container is the sub-container in the first position and adjacent to the first sub-container.

In order to further improve the game experience of the player, after the step of controlling the target sub-container to be displayed in the first designated sub-area, the above method further includes:
if the second sub-container in the target sub-containers other than the first sub-container is not displayed in the second display area, controlling a container identifier of the second sub-container to be displayed at a first edge position of the second display area; wherein the first edge position is an edge position closest to the second sub-container in the second display area.

The above first edge position can be the upper edge, lower edge, left edge or right edge of the second display area. If the first edge position is the upper edge and the lower edge, the distance judgment standard can be based on the Y axis of the preparation area; if the first edge position is the left edge and the right edge, the distance judgment standard can be based on the X axis of the preparation area. The container identifier of the second sub-container is displayed at the edge position closest to the second sub-container, which can be displayed as the name of the second sub-container and an arrow indication, wherein the second sub-container can be one or more, and both the first sub-container and the second sub-container are target sub-containers.

For example, after controlling the first sub-container closest to the first current position of the first virtual object to be displayed in the first designated sub-area of the second display area, due to the limited size of the graphical user interface, in order to prompt the player that other target sub-containers are hidden above or below the first sub-container in the second display area, as shown in FIG. 3, if the second sub-container is below the list of plurality of sub-containers, the name of the second sub-container A2 will be displayed at the lower edge of the second display area with an arrow indication, prompting the player that there is another target sub-container below the first sub-container A1 that can place the first virtual object.

It should be noted that, if the second display area can display up to three sub-containers, if there are two target sub-containers and the first designated sub-area is located at the upper edge or middle area of the second display area, the second display area can directly display the two target sub-containers. If the target sub-containers include four, one, two or even three sub-containers may not be displayed in the second display area. At this time, it is necessary to display the container identifier of one, two or even three sub-containers at the first edge position.

In this implementation, by displaying the container identifier of the target sub-container, it can prompt the player that there are other target sub-containers that can place the first virtual object in addition to the target container currently displayed in the first designated sub-area, which further improves operating efficiency and game experience of the player.

In order to further improve communication experience of the player, when there are a plurality of target sub-containers, after controlling the target sub-container to be displayed in the first designated sub-area, the method further includes:
determining a second designated sub-area in the second display area according to a second current position of a moved first virtual object in the second display area, in response to at least part of the first virtual object moving out from the first designated sub-area, and controlling the second sub-container of the target sub-containers to be displayed in the second designated sub-area; wherein the second current position is located in the second designated sub-area, or a distance between the second current position and the second designated sub-area is smaller than the preset threshold.

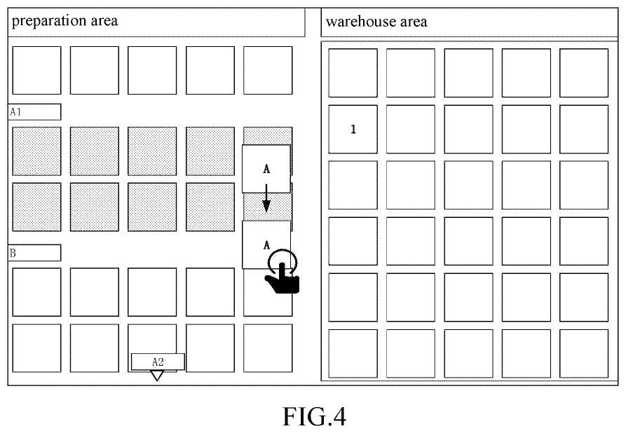

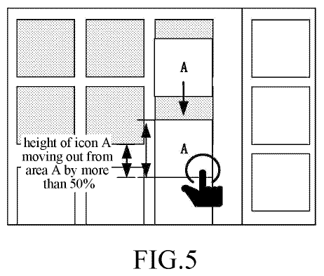

In actual implementation, in the first sub-container of the target sub-containers in the second display area, the first virtual object is clicked or selected to move from the first designated sub-area to the second sub-container of the target sub-container, as shown in FIG. 4, the first virtual object is moved out from the square of the first sub-container A1, and the icon of the first virtual object in the square disappears, and the icon of the first virtual object in the second display area is controlled to move toward the direction of the container identifier of the second sub-container of the target sub-container. In actual operation, as for the movement control operation of the first virtual object, it is necessary to control at least part of the first virtual object to move out from the first designated sub-area, as shown in FIG. 5, based on the Y axis of the preparation area as the distance judgment standard, the height of the icon of the first virtual object A can be controlled to move out from the first designated sub-area by more than 50% of its own height, which can trigger the control of the second sub-container to be displayed in the second designated sub-area of the second display area.

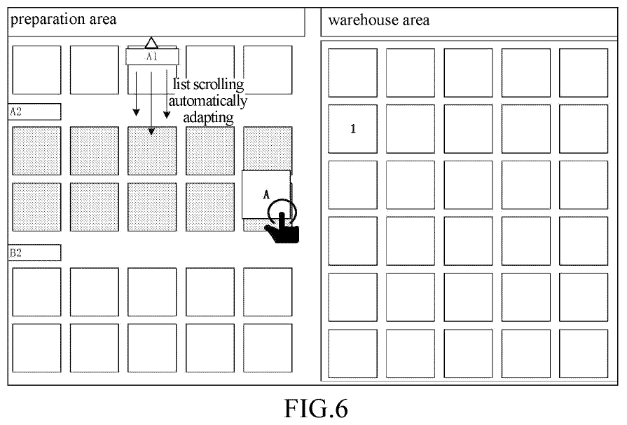

As shown in FIG. 4 and FIG. 5, the second current position is located below the first designated sub-area, and the second sub-container is controlled to be displayed in the second designated sub-area of the second display area. As shown in FIG. 6, after clicking or selecting the icon A of the first virtual object and moving it out from the first designated sub-area, the second display area will control the list to scroll upward according to the moving direction of the first virtual object, and automatically adapt the second sub-container A2 to move to the second current position of the first virtual object A or vicinity of the second current position, that is, the second designated sub-area. This makes the operation manner of finding the target sub-container in the second display area simpler and faster.

In this implementation, when there are a plurality of target sub-containers, by controlling the movement of the virtual object, the scrolling of the list can be triggered again, and the target sub-container in the moving direction can be automatically adapted to be displayed at the current position of the virtual object, making the operation manner of finding the target sub-container in the second display area simpler and faster.

After controlling the target sub-container to be displayed in the first designated sub-area, the method further includes: canceling the container identifier displayed at the first edge position of the second display area, if the first sub-container is not displayed in the second display area, controlling a container identifier of the first sub-container to be displayed at a second edge position of the second display area; wherein the first edge position and the second edge position are arranged oppositely in the second display area.

After the step of controlling the target sub-container to be displayed in the first designated sub-area, if the player controls the list of the current plurality of sub-containers to scroll, so that the first sub-container is not displayed in the second display area, the currently displayed container identifier will be controlled to be cancelled, and then the container identifier of the first sub-container will be displayed at the second edge position according to the scrolling direction of the scrolled first sub-container or the arrangement position of the list.

For example, after the icon of the first virtual object A is clicked or selected to move to the second current position, and then the second sub-container, such as the second sub-container A2 shown in FIG. 6, is controlled to be displayed in the second designated sub-area of the second display area, the container identifier shown in FIG. 4 of the second sub-container A2 displayed at the first edge position of the second display area before the second sub-container A2 is automatically adapted is cancelled. As shown in FIG. 4, the above-mentioned first edge position is the lower edge position of the second display area. Afterwards, the container identifier of the first sub-container, i.e., the name of the first sub-container A1 and an indicator arrow shown in FIG. 6, is controlled to be displayed at the upper edge position of the second display area, that is, the above-mentioned second edge position.

In this implementation, when the second display area displays a target sub-container, the container identifier of the target sub-container displayed at the edge is cancelled. When the second display area does not display a target sub-container, the container identifier of the target sub-container is displayed in the corresponding edge area, so that the player can understand the position of each target sub-container through the container identifier, further improving operation efficiency and game experience of the player.

In order to further improve game experience of the player, after determining the target sub-container for placing the first virtual object from the plurality of sub-containers, the method further includes:
controlling the target sub-container to be displayed in the second display area in a designated display format.

The above designated display format is used to prompt the player that the first virtual object can be placed in the target sub-container. Specifically, after determining the target sub-container for placing the first virtual object from the plurality of sub-containers in the second display area, the target sub-container is controlled to be displayed in the second display area in a designated display format. The designated display format can be highlight color display, flashing display, or mask display, etc. As shown in FIG. 2, the target sub-container A1 and the target sub-container A2 indicate the above designated display format in a gray display mode, which is mainly used to prompt the player that the sub-container displayed in gray is the target sub-container.

In this implementation, the target sub-container is displayed by specifying the display format, so that the player can intuitively learn about the sub-container in which the first virtual object can be placed, which reduces understanding cost of the game by the player and improves gaming experience of the player.

When there are a plurality of target sub-containers, a possible implementation of controlling the target sub-container to be displayed in the second display area in the designated display format is:
controlling the first sub-container of a first sequence in the target sub-containers to be displayed in an area corresponding to a third edge position of the second display area in the designated display format, according to an arrangement sequence of the plurality of target sub-containers; wherein the third edge position is an edge position corresponding to a first scrolling direction of the second display area;
if the second sub-container in the target sub-containers following the first sub-container is not displayed in the second display area, controlling a container identifier of the second sub-container to be displayed at a fourth edge position of the second display area; wherein the fourth edge position is an edge position corresponding to a second scrolling direction of the second display area; the first scrolling direction is opposite to the second scrolling direction.

Specifically, if the scrollable direction of the second display area is up and down scrolling, the first scrolling direction is the upward scrolling direction, that is, the third edge position is the upper edge position of the second display area, and the second scrolling direction is downward scrolling, that is, the fourth edge position is the lower edge position of the second display area; if the scrollable direction of the second display area is left and right scrolling, the first scrolling direction is leftward scrolling, that is, the third edge position is the left edge position of the second display area, and the second scrolling direction is rightward scrolling, that is, the fourth edge position is the right edge position of the second display area.

Take the above first scrolling direction as the upward scrolling direction, that is, the above third edge position is the upper edge position of the second display area, and the above second scrolling direction is the downward scrolling, that is, the above fourth edge position is the lower edge position of the second display area as an example for illustration, the player clicks or selects the first virtual object in the first display area to perform a movement control operation. According to the arrangement sequence of the target sub-containers, as shown in FIG. 2, the first sub-container A1 is displayed in the area corresponding to the upper edge position of the second display area. In the actual game scene, usually after the above first sub-container, part or all of the second sub-container is still displayed in the area corresponding to the fourth edge position of the second display area. As shown in FIG. 2, the above fourth edge position corresponds to the lower edge of the second display area. Alternatively, when the second sub-container is in a hidden state, the container identifier of the second sub-container, that is, the name of the second sub-container and the arrow with a direction indication, is displayed at the fourth edge position of the second display area, and the above fourth edge position corresponds to the second display area scrolling downward.

The above manner is highly practical, which increases the identification of object types when transferring materials, reduces the time that players spend searching for positions when transferring materials from the warehouse area to the preparation area, and greatly increases operation efficiency. When transferring materials, players are given clear slot numbers and operation direction targets to reduce the entry threshold for novice players. When a material can be stored in a plurality of category slots, the movement direction of the player can be determined through slight up and down movement of the player, which greatly reduces operating cost of the player, reduces the response frequency of hardware devices, and helps save computing resources of hardware devices.

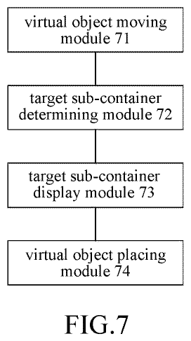

Corresponding to the above method embodiment, FIG. 7 shows an operation control apparatus of a virtual object, wherein a terminal device generally provides a graphical user interface, the graphical user interface includes a first display area of a first storage container and a second display area of a second storage container; wherein the second storage container includes a plurality of sub-containers; wherein the apparatus includes:
a virtual object moving module 71, configured to control a first virtual object to move, in response to a movement control operation for the first virtual object in the first storage container;
a target sub-container determining module 72, configured to determine a target sub-container for placing the first virtual object from the plurality of sub-containers;
a target sub-container display module 73, configured to determine a first designated sub-area in the second display area based on a first current position of the first virtual object in the second display area, in response to the first virtual object moving to the second display area, and control the target sub-container to be displayed in the first designated sub-area of the second display area; wherein the first current position is located in the first designated sub-area, or a distance between the first current position and the first designated sub-area is smaller than a preset threshold; and
a virtual object placing module 74, configured to place the first virtual object in the target sub-container, in response to end of the movement control operation.

In the above operation control apparatus of a virtual object, a first virtual object is controlled to move, in response to a movement control operation for the first virtual object in the first storage container; a target sub-container for placing the first virtual object is determined from the plurality of sub-containers; a first designated sub-area is determined in the second display area based on a first current position of the first virtual object in the second display area, in response to the first virtual object moving to the second display area, and the target sub-container is controlled to be displayed in the first designated sub-area of the second display area; wherein the first current position is located in the first designated sub-area, or a distance between the first current position and the first designated sub-area is smaller than a preset threshold; and the first virtual object is placed in the target sub-container, in response to end of the movement control operation. In this implementation, when the first virtual object is moved from the first storage container to the second storage container, the target sub-container where the first virtual object is placed is intelligently identified, and the target sub-container is quickly positioned at the first current position where the first virtual object is located, without requiring the player to drag the object and slide it up and down in the second storage container, thereby reducing the operation time of dragging the object up and down to find the target sub-container, improving the operation efficiency, reducing understanding requirements of the player on the game and the trial and error cost, reducing the response frequency of the hardware device, and helping to save the computing resources of the hardware device.

In at least one embodiment, the virtual object moving module includes: controlling the first virtual object to move out from the first position, in response to the movement control operation for the first virtual object in the first storage container.

In at least one embodiment, the virtual object moving module includes: determining the target sub-container capable of placing the first virtual object from the plurality of sub-containers, according to an object type of the first virtual object and a container type of the sub-container.

In at least one embodiment, the second storage container includes a plurality of sub-containers arranged in a designated sequence; the target sub-container display module includes: controlling the second display area to be scrolled, such that the target sub-container in the plurality of sub-containers is displayed in the first designated sub-area; wherein the designated arrangement sequence of the plurality of sub-containers is unchanged.

In at least one embodiment, the second storage container includes a plurality of sub-containers arranged in a designated sequence; the target sub-container display module includes: controlling the target sub-container in the plurality of sub-containers to move out from a current position and move to the first designated sub-area.

In at least one embodiment, when there are a plurality of target sub-containers, the target sub-container display module includes: controlling the second display area to be scrolled, such that the first sub-container in the target sub-containers closest to the first current position is displayed in the first designated sub-area.

In at least one embodiment, when there are a plurality of target sub-containers, the target sub-container display module includes: controlling the plurality of target sub-containers to move out from the current position, such that the first sub-container in the target sub-containers closest to the first current position is moved to the first designated sub-area, and a second sub-container in the target sub-containers other than the first sub-container is moved to an adjacent area following the first sub-container; wherein the first sub-container and the second sub-container are arranged in the designated sequence.

In at least one embodiment, the above apparatus further includes: a container identifier first display module, configured to: if the second sub-container in the target sub-containers other than the first sub-container is not displayed in the second display area, control a container identifier of the second sub-container to be displayed at a first edge position of the second display area; wherein the first edge position is an edge position closest to the second sub-container in the second display area.

In at least one embodiment, when there are a plurality of target sub-containers, the above apparatus further includes: a container identifier second display module, configured to: determine a second designated sub-area in the second display area according to a second current position of a moved first virtual object in the second display area, in response to at least part of the first virtual object moving out from the first designated sub-area, and control the second sub-container of the target sub-containers to be displayed in the second designated sub-area; wherein the second current position is located in the second designated sub-area, or a distance between the second current position and the second designated sub-area is smaller than the preset threshold.

In at least one embodiment, the above apparatus further includes: a container identifier third display module, configured to: cancel the container identifier displayed at the first edge position of the second display area, if the first sub-container is not displayed in the second display area; control a container identifier of the first sub-container to be displayed at a second edge position of the second display area; wherein the first edge position and the second edge position are arranged oppositely in the second display area.

In at least one embodiment, the above apparatus further includes: a six display module, configured to: control the target sub-container to be displayed in the second display area in a designated display format.

In at least one embodiment, when there are a plurality of target sub-containers, the above virtual object moving module includes: controlling the first sub-container of a first sequence in the target sub-containers to be displayed in an area corresponding to a third edge position of the second display area in the designated display format, according to an arrangement sequence of the plurality of target sub-containers; wherein the third edge position is an edge position corresponding to a first scrolling direction of the second display area; if the second sub-container in the target sub-containers following the first sub-container is not displayed in the second display area, controlling a container identifier of the second sub-container to be displayed at a fourth edge position of the second display area; wherein the fourth edge position is an edge position corresponding to a second scrolling direction of the second display area; the first scrolling direction is opposite to the second scrolling direction.

The operation control apparatus of the virtual object provided in the embodiment of the present disclosure has the same technical features as the operation control method of the virtual object provided in the above embodiment, so it can also solve the same technical problem and achieve the same technical effect.

This embodiment also provides an electronic device, including a processor and a memory, wherein the memory stores computer executable instructions executable by the processor, and the processor executes the computer executable instructions to implement the above-mentioned operation control method of the virtual object. The electronic device can be a server or a touch terminal device.

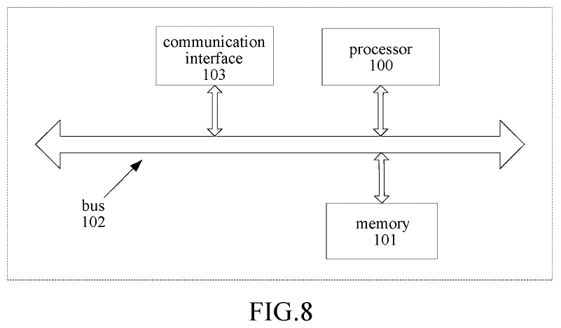

Referring to FIG. 8, the electronic device includes a processor 100 and a memory 101. The memory 101 stores machine executable instructions that can be executed by the processor 100. The processor 100 executes the machine executable instructions to implement the above-mentioned operation control method of the virtual object. The method generally provides a graphical user interface on the terminal device. The terminal device generally provides a graphical user interface, the graphical user interface includes a first display area of a first storage container and a second display area of a second storage container; wherein the second storage container includes a plurality of sub-containers; wherein the method includes following steps:

controlling a first virtual object to move, in response to a movement control operation for the first virtual object in the first storage container; determining a target sub-container for placing the first virtual object from the plurality of sub-containers; determining a first designated sub-area in the second display area based on a first current position of the first virtual object in the second display area, in response to the first virtual object moving to the second display area, and controlling the target sub-container to be displayed in the first designated sub-area of the second display area; wherein the first current position is located in the first designated sub-area, or a distance between the first current position and the first designated sub-area is smaller than a preset threshold; and placing the first virtual object in the target sub-container, in response to end of the movement control operation. In this implementation, when the first virtual object is moved from the first storage container to the second storage container, the target sub-container where the first virtual object is placed is intelligently identified, and the target sub-container is quickly positioned at the first current position where the first virtual object is located, without requiring the player to drag the object and slide it up and down in the second storage container, thereby reducing the operation time of dragging the object up and down to find the target sub-container, improving the operation efficiency, reducing understanding requirements of the player on the game and the trial and error cost, reducing the response frequency of the hardware device, and helping to save the computing resources of the hardware device.

In at least one embodiment, the first virtual object is placed at a first position in the first storage container in advance; controlling movement of the first virtual object, in response to the movement control operation for the first virtual object in the first storage container includes: controlling the first virtual object to move out from the first position, in response to the movement control operation for the first virtual object in the first storage container. In this implementation, when the first virtual object is controlled to move out from the first position, immediate feedback is given to the movement control operation of the player, which is conducive to understanding and operation of the player.

In at least one embodiment, determining the target sub-container for placing the first virtual object from the plurality of sub-containers includes: determining the target sub-container capable of placing the first virtual object from the plurality of sub-containers, according to an object type of the first virtual object and a container type of the sub-container.

In at least one embodiment, the second storage container includes a plurality of sub-containers arranged in a designated sequence; controlling the target sub-container to be displayed in the first designated sub-area includes: controlling the second display area to be scrolled, such that the target sub-container in the plurality of sub-containers is displayed in the first designated sub-area; wherein the designated arrangement sequence of the plurality of sub-containers is unchanged.

In at least one embodiment, the second storage container includes a plurality of sub-containers arranged in a designated sequence; controlling the target sub-container to be displayed in the first designated sub-area includes: controlling the target sub-container in the plurality of sub-containers to move out from a current position and move to the first designated sub-area.

In at least one embodiment, when there are a plurality of target sub-containers, controlling the target sub-container to be displayed in the first designated sub-area of the second display area includes: controlling the second display area to be scrolled, such that the first sub-container in the target sub-containers closest to the first current position is displayed in the first designated sub-area. In this implementation, when the first virtual object is dragged to the second display area, the list of plurality of sub-containers is controlled to scroll, so that the target sub-container closest to the first virtual object is displayed in the first designated sub-area, so that there is sufficient feedback on which position the virtual object can be stored in, which further improves the operation efficiency.

In at least one embodiment, when there are a plurality of target sub-containers, controlling the target sub-container to be displayed in the first designated sub-area includes: controlling the plurality of target sub-containers to move out from the current position, such that the first sub-container in the target sub-containers closest to the first current position is moved to the first designated sub-area, and a second sub-container in the target sub-containers other than the first sub-container is moved to an adjacent area following the first sub-container; wherein the first sub-container and the second sub-container are arranged in the designated sequence.

In at least one embodiment, after controlling the target sub-container to be displayed in the first designated sub-area, the method further includes: if the second sub-container in the target sub-containers other than the first sub-container is not displayed in the second display area, controlling a container identifier of the second sub-container to be displayed at a first edge position of the second display area; wherein the first edge position is an edge position closest to the second sub-container in the second display area. In this implementation, by displaying the container identifier of the target sub-container, it can prompt the player that there are other target sub-containers that can place the first virtual object in addition to the target container currently displayed in the first designated sub-area, which further improves operating efficiency and game experience of the player.

In at least one embodiment, when there are a plurality of target sub-containers, after controlling the target sub-container to be displayed in the first designated sub-area, the method further includes: determining a second designated sub-area in the second display area according to a second current position of a moved first virtual object in the second display area, in response to at least part of the first virtual object moving out from the first designated sub-area, and controlling the second sub-container of the target sub-containers to be displayed in the second designated sub-area of the second display area; wherein the second current position is located in the second designated sub-area, or a distance between the second current position and the second designated sub-area is smaller than the preset threshold. In this implementation, when there are a plurality of target sub-containers, by controlling the movement of the virtual object, the scrolling of the list can be triggered again, and the target sub-container in the moving direction can be automatically adapted to be displayed at the current position of the virtual object, making the operation manner of finding the target sub-container in the second display area simpler and faster.

In at least one embodiment, after controlling the target sub-container to be displayed in the first designated sub-area, the method further includes: canceling the container identifier displayed at the first edge position of the second display area, if the first sub-container is not displayed in the second display area; controlling a container identifier of the first sub-container to be displayed at a second edge position of the second display area; wherein the first edge position and the second edge position are arranged oppositely in the second display area. In this implementation, when the second display area displays a target sub-container, the container identifier of the target sub-container displayed at the edge is cancelled. When the second display area does not display a target sub-container, the container identifier of the target sub-container is displayed in the corresponding edge area, so that the player can understand the position of each target sub-container through the container identifier, further improving operation efficiency and game experience of the player.

In at least one embodiment, after determining the target sub-container for placing the first virtual object from the plurality of sub-containers, the method further includes: controlling the target sub-container to be displayed in the second display area in a designated display format. In this implementation, the target sub-container is displayed by specifying the display format, so that the player can intuitively learn about the sub-container in which the first virtual object can be placed, which reduces understanding cost of the game by the player and improves gaming experience of the player.

In at least one embodiment, when there are a plurality of target sub-containers, controlling the target sub-container to be displayed in the second display area in the designated display format includes: controlling the first sub-container of a first sequence in the target sub-containers to be displayed in an area corresponding to a third edge position of the second display area in the designated display format, according to an arrangement sequence of the plurality of target sub-containers; wherein the third edge position is an edge position corresponding to a first scrolling direction of the second display area; if the second sub-container in the target sub-containers following the first sub-container is not displayed in the second display area, controlling a container identifier of the second sub-container to be displayed at a fourth edge position of the second display area; wherein the fourth edge position is an edge position corresponding to a second scrolling direction of the second display area; the first scrolling direction is opposite to the second scrolling direction.

Further, the electronic device in FIG. 8 further includes a bus 102 and a communication interface 103, and the processor 100, the communication interface 103 and the memory 101 are connected through the bus 102.

The memory 101 may include a high-speed random access memory (RAM) and may also include a non-volatile memory, such as at least one disk memory. The communication connection between the system network element and at least one other network element is realized through at least one communication interface 103 (which can be wired or wireless), and the Internet, wide area network, local network, metropolitan area network, etc. can be used. The bus 102 can be an ISA bus, a PCI bus or an EISA bus, etc. The bus can be divided into an address bus, a data bus, a control bus, etc. For ease of representation, FIG. 8 is represented by a bidirectional arrow; but it does not mean that there is only one bus or one type of bus.

The processor 100 may be an integrated circuit chip with signal processing capabilities. In the implementation process, each step of the above method can be completed by a hardware integrated logic circuit or software instructions in the processor 100. The above processor 100 can be a general-purpose processor, including a central processing unit (CPU), a network processor (NP), etc.; it can also be a digital signal processor (DSP), an application specific integrated circuit (ASIC), a field-programmable gate array (FPGA), or other programmable logic devices, discrete gates or transistor logic devices, discrete hardware components. The methods, steps and logic diagrams disclosed in the embodiments of the present disclosure can be implemented or executed. The general processor can be a microprocessor or the processor can also be any conventional processor, etc. The steps of the method disclosed in the embodiments of the present disclosure can be directly embodied as being executed by a hardware decoding processor, or can be executed by a combination of hardware and software modules in the decoding processor. The software module can be located in a mature storage medium in the art, such as a random access memory, a flash memory, a read-only memory, a programmable read-only memory or an electrically erasable programmable memory, a register, etc. The storage medium is located in the memory 101, and the processor 100 reads the information in the memory 101 and completes the steps of the method of the aforementioned embodiment in combination with its hardware.

This embodiment also provides a machine-readable storage medium, which stores machine-executable instructions. When the machine-executable instructions are called and executed by the processor, the machine-executable instructions prompt the processor to implement the above-mentioned operation control method of a virtual object. The method generally provides a graphical user interface on a terminal device, the graphical user interface includes a first display area of a first storage container and a second display area of a second storage container; wherein the second storage container includes a plurality of sub-containers; wherein the method includes following steps:
controlling a first virtual object to move, in response to a movement control operation for the first virtual object in the first storage container; determining a target sub-container for placing the first virtual object from the plurality of sub-containers; determining a first designated sub-area in the second display area based on a first current position of the first virtual object in the second display area, in response to the first virtual object moving to the second display area, and controlling the target sub-container to be displayed in the first designated sub-area of the second display area; wherein the first current position is located in the first designated sub-area, or a distance between the first current position and the first designated sub-area is smaller than a preset threshold; and placing the first virtual object in the target sub-container, in response to end of the movement control operation. In this implementation, when the first virtual object is moved from the first storage container to the second storage container, the target sub-container where the first virtual object is placed is intelligently identified, and the target sub-container is quickly positioned at the first current position where the first virtual object is located, without requiring the player to drag the object and slide it up and down in the second storage container, thereby reducing the operation time of dragging the object up and down to find the target sub-container, improving the operation efficiency, reducing understanding requirements of the player on the game and the trial and error cost, reducing the response frequency of the hardware device, and helping to save the computing resources of the hardware device.

In at least one embodiment, the first virtual object is placed at a first position in the first storage container in advance; controlling movement of the first virtual object, in response to the movement control operation for the first virtual object in the first storage container includes: controlling the first virtual object to move out from the first position, in response to the movement control operation for the first virtual object in the first storage container. In this implementation, when the first virtual object is controlled to move out from the first position, immediate feedback is given to the movement control operation of the player, which is conducive to understanding and operation of the player.

In at least one embodiment, determining the target sub-container for placing the first virtual object from the plurality of sub-containers includes: determining the target sub-container capable of placing the first virtual object from the plurality of sub-containers, according to an object type of the first virtual object and a container type of the sub-container.

In at least one embodiment, the second storage container includes a plurality of sub-containers arranged in a designated sequence; controlling the target sub-container to be displayed in the first designated sub-area includes: controlling the second display area to be scrolled, such that the target sub-container in the plurality of sub-containers is displayed in the first designated sub-area; wherein the designated arrangement sequence of the plurality of sub-containers is unchanged.

In at least one embodiment, the second storage container includes a plurality of sub-containers arranged in a designated sequence; controlling the target sub-container to be displayed in the first designated sub-area includes: controlling the target sub-container in the plurality of sub-containers to move out from a current position and move to the first designated sub-area.

In at least one embodiment, when there are a plurality of target sub-containers, controlling the target sub-container to be displayed in the first designated sub-area of the second display area includes: controlling the second display area to be scrolled, such that the first sub-container in the target sub-containers closest to the first current position is displayed in the first designated sub-area. In this implementation, when the first virtual object is dragged to the second display area, the list of plurality of sub-containers is controlled to scroll, so that the target sub-container closest to the first virtual object is displayed in the first designated sub-area, so that there is sufficient feedback on which position the virtual object can be stored in, which further improves the operation efficiency.

In at least one embodiment, when there are a plurality of target sub-containers, controlling the target sub-container to be displayed in the first designated sub-area includes: controlling the plurality of target sub-containers to move out from the current position, such that the first sub-container in the target sub-containers closest to the first current position is moved to the first designated sub-area, and a second sub-container in the target sub-containers other than the first sub-container is moved to an adjacent area following the first sub-container; wherein the first sub-container and the second sub-container are arranged in the designated sequence.

In at least one embodiment, after controlling the target sub-container to be displayed in the first designated sub-area, the method further includes: if the second sub-container in the target sub-containers other than the first sub-container is not displayed in the second display area, controlling a container identifier of the second sub-container to be displayed at a first edge position of the second display area; wherein the first edge position is an edge position closest to the second sub-container in the second display area. In this implementation, by displaying the container identifier of the target sub-container, it can prompt the player that there are other target sub-containers that can place the first virtual object in addition to the target container currently displayed in the first designated sub-area, which further improves operating efficiency and game experience of the player.

In at least one embodiment, when there are a plurality of target sub-containers, after controlling the target sub-container to be displayed in the first designated sub-area, the method further includes: determining a second designated sub-area in the second display area according to a second current position of a moved first virtual object in the second display area, in response to at least part of the first virtual object moving out from the first designated sub-area, and controlling the second sub-container of the target sub-containers to be displayed in the second designated sub-area of the second display area; wherein the second current position is located in the second designated sub-area, or a distance between the second current position and the second designated sub-area is smaller than the preset threshold. In this implementation, when there are a plurality of target sub-containers, by controlling the movement of the virtual object, the scrolling of the list can be triggered again, and the target sub-container in the moving direction can be automatically adapted to be displayed at the current position of the virtual object, making the operation manner of finding the target sub-container in the second display area simpler and faster.

In at least one embodiment, after controlling the target sub-container to be displayed in the first designated sub-area, the method further includes: canceling the container identifier displayed at the first edge position of the second display area, if the first sub-container is not displayed in the second display area; controlling a container identifier of the first sub-container to be displayed at a second edge position of the second display area; wherein the first edge position and the second edge position are arranged oppositely in the second display area. In this implementation, when the second display area displays a target sub-container, the container identifier of the target sub-container displayed at the edge is cancelled. When the second display area does not display a target sub-container, the container identifier of the target sub-container is displayed in the corresponding edge area, so that the player can understand the position of each target sub-container through the container identifier, further improving operation efficiency and game experience of the player.

In at least one embodiment, after determining the target sub-container for placing the first virtual object from the plurality of sub-containers, the method further includes: controlling the target sub-container to be displayed in the second display area in a designated display format. In this implementation, the target sub-container is displayed by specifying the display format, so that the player can intuitively learn about the sub-container in which the first virtual object can be placed, which reduces understanding cost of the game by the player and improves gaming experience of the player.

In at least one embodiment, when there are a plurality of target sub-containers, controlling the target sub-container to be displayed in the second display area in the designated display format includes: controlling the first sub-container of a first sequence in the target sub-containers to be displayed in an area corresponding to a third edge position of the second display area in the designated display format, according to an arrangement sequence of the plurality of target sub-containers; wherein the third edge position is an edge position corresponding to a first scrolling direction of the second display area; if the second sub-container in the target sub-containers following the first sub-container is not displayed in the second display area, controlling a container identifier of the second sub-container to be displayed at a fourth edge position of the second display area; wherein the fourth edge position is an edge position corresponding to a second scrolling direction of the second display area; the first scrolling direction is opposite to the second scrolling direction.

The operation control method and apparatus of the virtual object, the electronic device and the computer program product of the storage medium provided in the embodiment of the present disclosure include a computer-readable storage medium storing program codes, and the instructions included in the program codes can be used to execute the method described in the previous method embodiments. The specific implementation can refer to the method embodiments, which will not be repeated herein.

Those skilled in the art can clearly understand that, for the convenience and simplicity of description, the specific working process of the system and apparatus described above can refer to the corresponding process in the previous method embodiments, which will not be repeated herein.

In addition, in the description of the embodiments of the present disclosure, unless otherwise clearly specified and limited, the terms “installation”, “connection” and “connecting” should be understood in a broad sense, for example, it can be a fixed connection, a detachable connection, or an integral connection; it can be a mechanical connection or an electrical connection; it can be a direct connection, or it can be indirectly connected through an intermediate medium, or it can be the internal connection of two components. For those skilled in the art, the specific meanings of the above terms in the present disclosure can be understood according to the specific situation.

If the function is implemented in the form of a software functional unit and sold or used as an independent product, it can be stored in a computer-readable storage medium. Based on this understanding, the technical solution of the present disclosure is essentially or the part that contributes to the relevant technology or the part of the technical solution can be embodied in the form of a software product, the computer software product is stored in a storage medium and includes several instructions for a computer device (which can be a personal computer, a server, or a network device, etc.) to perform all or part of the steps of the method described in each embodiment of the present disclosure. The aforementioned storage medium includes: U disk, mobile hard disk, read-only memory (ROM), random access memory (RAM), disk or optical disk and other media that can store program codes.

In the description of the present disclosure, it should be noted that positions or positional relationships indicated by the terms “center”, “upper”, “lower”, “left”, “right”, “vertical”, “horizontal”, “inside”, “outside” and the like are based on the positions or positional relationships shown in the accompanying drawings, which are only for the convenience of describing the present disclosure and simplifying the description, and do not indicate or imply that the apparatus or element referred to must have a specific position, be constructed and operated in a specific position, and therefore cannot be understood as limiting the present disclosure. In addition, the terms “first”, “second”, and “third” are only used for descriptive purposes and cannot be understood as indicating or implying relative importance.

Finally, it should be noted that, the above embodiments are only specific implementations of the present disclosure, which are used to illustrate the technical solutions of the present disclosure, rather than to limit them. The protection scope of the present disclosure is not limited thereto. Although the present disclosure is described in detail with reference to the above embodiments, those skilled in the art should understand that, any person skilled in the art can still modify the technical solutions recorded in the above embodiments within the technical scope disclosed in the present disclosure, or can easily conceive changes, or make equivalent replacements for some of the technical features therein; and these modifications, changes or replacements do not make the essence of the corresponding technical solutions deviate from the spirit and scope of the technical solutions of the embodiments of the present disclosure, and should be covered within the protection scope of the present disclosure. Therefore, the protection scope of the present disclosure should be based on the protection scope of the claims.

1. An operation control method of a virtual object, comprising:
providing a graphical user interface through a terminal device, wherein the graphical user interface comprises a first display area of a first storage container and a second display area of a second storage container; wherein the second storage container comprises a plurality of sub-containers;
controlling a first virtual object to move, in response to a movement control operation for the first virtual object in the first storage container;
determining a target sub-container for placing the first virtual object from the plurality of sub-containers;
determining a first designated sub-area in the second display area based on a first current position of the first virtual object in the second display area, in response to the first virtual object moving to the second display area, and controlling the target sub-container to be displayed in the first designated sub-area; wherein the first current position is located in the first designated sub-area, or a distance between the first current position and the first designated sub-area is smaller than a preset threshold; and
placing the first virtual object in the target sub-container, in response to end of the movement control operation.

2. The method according to claim 1, wherein the first virtual object is placed at a first position in the first storage container in advance;
wherein controlling movement of the first virtual object, in response to the movement control operation for the first virtual object in the first storage container comprises:
controlling the first virtual object to move out from the first position, in response to the movement control operation for the first virtual object in the first storage container.

3. The method according to claim 1, wherein determining the target sub-container for placing the first virtual object from the plurality of sub-containers comprises:
determining the target sub-container capable of placing the first virtual object from the plurality of sub-containers, according to an object type of the first virtual object and a container type of the sub-container.

4. The method according to claim 1, wherein the second storage container comprises a plurality of sub-containers arranged in a designated sequence:
controlling the target sub-container to be displayed in the first designated sub-area comprises:
controlling the second display area to be scrolled, such that the target sub-container in the plurality of sub-containers is displayed in the first designated sub-area; wherein the designated arrangement sequence of the plurality of sub-containers is unchanged.

5. The method according to claim 1, wherein the second storage container comprises a plurality of sub-containers arranged in a designated sequence:
controlling the target sub-container to be displayed in the first designated sub-area comprises:
controlling the target sub-container in the plurality of sub-containers to move out from a current position and move to the first designated sub-area.

6. The method according to claim 4, wherein in response to detecting a plurality of target sub-containers, controlling the target sub-container to be displayed in the first designated sub-area comprises:
controlling the second display area to be scrolled, such that the first sub-container in the target sub-containers closest to the first current position is displayed in the first designated sub-area.

7. The method according to claim 5, wherein in response to detecting a plurality of target sub-containers, controlling the target sub-container to be displayed in the first designated sub-area comprises:
controlling the plurality of target sub-containers to move out from the current position, such that the first sub-container in the target sub-containers closest to the first current position is moved to the first designated sub-area, and a second sub-container in the target sub-containers other than the first sub-container is moved to an adjacent area following the first sub-container;
wherein the first sub-container and the second sub-container are arranged in the designated sequence.

8. The method according to claim 6, wherein further comprising:
in response to determining that the second sub-container in the target sub-containers other than the first sub-container is not displayed in the second display area, controlling a container identifier of the second sub-container to be displayed at a first edge position of the second display area; wherein the first edge position is an edge position closest to the second sub-container in the second display area.

9. The method according to claim 1, wherein in response to detecting a plurality of target sub-containers, the method further comprises:
determining a second designated sub-area in the second display area according to a second current position of a moved first virtual object in the second display area, in response to at least part of the first virtual object moving out from the first designated sub-area, and controlling the second sub-container of the target sub-containers to be displayed in the second designated sub-area; wherein the second current position is located in the second designated sub-area, or a distance between the second current position and the second designated sub-area is smaller than the preset threshold.

10. The method according to claim 8, further comprising:
canceling the container identifier displayed at the first edge position of the second display area, in response to determining that the first sub-container is not displayed in the second display area;
controlling a container identifier of the first sub-container to be displayed at a second edge position of the second display area; wherein the first edge position and the second edge position are arranged oppositely in the second display area.

11. The method according to claim 1, further comprising:
controlling the target sub-container to be displayed in the second display area in a designated display format.

12. The method according to claim 11, wherein in response to detecting a plurality of target sub-containers, controlling the target sub-container to be displayed in the second display area in the designated display format comprises:
controlling the first sub-container of a first sequence in the target sub-containers to be displayed in an area corresponding to a third edge position of the second display area in the designated display format, according to an arrangement sequence of the plurality of target sub-containers: wherein the third edge position is an edge position corresponding to a first scrolling direction of the second display area;
in response to determining that the second sub-container in the target sub-containers following the first sub-container is not displayed in the second display area, controlling a container identifier of the second sub-container to be displayed at a fourth edge position of the second display area; wherein the fourth edge position is an edge position corresponding to a second scrolling direction of the second display area; the first scrolling direction is opposite to the second scrolling direction.

13. (canceled)

14. An electronic device, comprising a processor and a memory, wherein the memory stores computer executable instructions executable by the processor, and the computer executable instructions are executed by the processor, the processor is configured to:
provide a graphical user interface, wherein the graphical user interface comprises a first display area of a first storage container and a second display area of a second storage container; wherein the second storage container comprises a plurality of sub-containers;
control a first virtual object to move, in response to a movement control operation for the first virtual object in the first storage container;
determine a target sub-container for placing the first virtual object from the plurality of sub-containers;
determine a first designated sub-area in the second display area based on a first current position of the first virtual object in the second display area, in response to the first virtual object moving to the second display area, and controlling the target sub-container to be displayed in the first designated sub-area; wherein the first current position is located in the first designated sub-area, or a distance between the first current position and the first designated sub-area is smaller than a preset threshold; and
place the first virtual object in the target sub-container, in response to end of the movement control operation.

15. A non-transitory computer-readable storage medium, having computer executable instructions stored thereon, wherein the computer executable instructions prompt a processor to implement following operations when called and executed by the processor:
providing a graphical user interface through a terminal device, wherein the graphical user interface comprises a first display area of a first storage container and a second display area of a second storage container; wherein the second storage container comprises a plurality of sub-containers;
controlling a first virtual object to move, in response to a movement control operation for the first virtual object in the first storage container;
determining a target sub-container for placing the first virtual object from the plurality of sub-containers;
determining a first designated sub-area in the second display area based on a first current position of the first virtual object in the second display area, in response to the first virtual object moving to the second display area, and controlling the target sub-container to be displayed in the first designated sub-area; wherein the first current position is located in the first designated sub-area, or a distance between the first current position and the first designated sub-area is smaller than a preset threshold; and
placing the first virtual object in the target sub-container, in response to end of the movement control operation.

16. The electronic device according to claim 14, wherein the processor is further configured to:
control the target sub-container to be displayed in the second display area in a designated display format.

17. The electronic device according to claim 16, wherein designated display format is highlight color display, flashing display, or mask display.

18. The electronic device according to claim 16, wherein the processor is further configured to:
control the first sub-container of a first sequence in the target sub-containers to be displayed in an area corresponding to a third edge position of the second display area in the designated display format, according to an arrangement sequence of the plurality of target sub-containers: wherein the third edge position is an edge position corresponding to a first scrolling direction of the second display area;
in response to determining that the second sub-container in the target sub-containers following the first sub-container is not displayed in the second display area, control a container identifier of the second sub-container to be displayed at a fourth edge position of the second display area; wherein the fourth edge position is an edge position corresponding to a second scrolling direction of the second display area; the first scrolling direction is opposite to the second scrolling direction.

19. The electronic device according to claim 18, wherein in response to that a scrollable direction of the second display area is up and down scrolling, the first scrolling direction is an upward scrolling direction and the second scrolling direction is a downward scrolling direction; in response to that the scrollable direction of the second display area is left and right scrolling, the first scrolling direction is a leftward scrolling direction and the second scrolling direction is a rightward scrolling direction.

20. The electronic device according to claim 14, wherein the processor is further configured to:
control the first virtual object to move out from the first position, in response to the movement control operation for the first virtual object in the first storage container.

21. The non-transitory computer-readable storage medium according to claim 15, wherein the first virtual object is placed at a first position in the first storage container in advance:
wherein the processor is further configured to:
control the first virtual object to move out from the first position, in response to the movement control operation for the first virtual object in the first storage container.
